(19) United States
(12) Patent Application Publication
(10) Pub. No.: US 2023/0015305 A1
(43) Pub. Date: Jan. 19, 2023

(54) Method and Reprocessing System for Reprocessing Plastic Waste Material, In Particular PET Waste Material

(71) Applicant: Coperion GmbH, Stuttgart (DE)

(72) Inventors: Marina MATTA, Gemmingen (DE); Klaus-Peter LANG, Bad Waldsee (DE)

(73) Assignee: Coperion GmbH, Stuttgart (DE)

(21) Appl. No.: 17/864,756

(22) Filed: Jul. 14, 2022

(30) Foreign Application Priority Data
Jul. 16, 2021 (DE) 10 2021 207 614.9

(51) Int. Cl. B29B 7/48; B29B 7/84; C08J 11/06

(52) U.S. Cl. CPC B29B 7/48; B29B 7/847; C08J 11/06; B29B 2017/001

(57) ABSTRACT

In a method for reprocessing plastic waste material, in embodiments PET waste material, the plastic waste material is dried by a flash dryer in a conveying line and then fed into a multi-shaft screw machine. In the multi-shaft screw machine, the dried plastic waste material is reprocessed. Pre-drying enables simple, energy-efficient, economical, reliable and effective reprocessing.

### CROSS-REFERENCES TO RELATED APPLICATIONS

This application claims the priority of German Patent Application, Serial No. DE 10 2021 207 614.9, filed Jul. 16, 2021, the content of which is incorporated herein by reference in its entirety as if fully set forth herein.

### FIELD

Embodiments of the disclosure relate to a method and a reprocessing system for reprocessing waste plastic material, in embodiments PET waste material.

### BACKGROUND

The reprocessing or recycling of PET waste material (PET: polyethylene terephthalate) is well known. For this purpose, PET waste, such as PET bottles, is shredded into PET waste material, which is then washed. Due to the washing process, the PET waste material has a high humidity proportion, which impairs the reprocessing of the PET waste material by a multi-shaft screw machine.

From WO 2006/079 128 A1 (corresponds to US 2009/0004325 A1) a method for reprocessing PET waste material to be recycled is known. The PET waste material is fed to an evacuated container in which moving tools are arranged. Due to the movement of the tools, the PET waste material in the container is heated, dried and at least partially crystallized. After drying and crystallization, the PET waste material is fed to a single-screw or multi-screw extruder for reprocessing.

### SUMMARY

It is an object of embodiments of the disclosure to provide a method which allows simple, energy-efficient, economical, reliable and effective reprocessing of plastic waste material, in embodiments PET waste material.

This object is achieved by a method for recycling plastic waste material, in embodiments PET waste material, comprising the following steps:
providing plastic waste material,
drying the plastic waste material by a flash dryer in a conveying line,
feeding the dried plastic waste material into a multi-shaft screw machine, and
reprocessing the dried plastic waste material by the multi-shaft screw machine. By the flash dryer, the moist plastic waste material is dried in the conveying line in a simple and quick manner. Due to the short dwell time of the plastic waste material in the conveying line, drying is energy-efficient and gentle for the plastic waste material. The plastic waste material is not stressed due to the drying process. The flash dryer has a simple design and requires little space, so that the investment and operating costs are low. As a result, an economical reprocessing of the plastic waste material is possible.

The flash dryer conveys the plastic waste material in a conveying direction in the conveying line. The flash dryer is arranged upstream of the multi-shaft screw machine in the conveying direction, so that the plastic waste material is dried or pre-dried by a conveying gas before being reprocessed. The process of drying the plastic waste material is thus a pre-drying process prior to reprocessing or recycling of the dried plastic waste material. Before being fed into the multi-shaft screw machine, the dried plastic waste material is separated from the conveying gas.

Since the plastic waste material is fed to the multi-shaft screw machine in a dried state, only a small amount of moisture has to be removed from the multi-shaft screw machine during reprocessing. For removing moisture, the multi-shaft screw machine has in embodiments at least one degassing installation. The degassing installation can be dimensioned to be smaller compared to a reprocessing of moist plastic waste material. Furthermore, by the method according to embodiments of the disclosure, the multi-shaft screw machine can be operated with a higher throughput, since the moisture released during reprocessing does not foam the material melt in the multi-shaft screw machine and clog the at least one degassing installation. The dried plastic waste material can thus be reprocessed reliably, effectively and with a high quality.

The plastic waste material is comminuted, in embodiments shredded. The plastic waste material is in embodiments formed as flakes, shreds and/or pellets. The plastic waste material is in embodiments a PET waste material (PET: polyethylene terephthalate). The plastic waste material is delivered in big bags, for example.

The multi-shaft screw machine comprises a housing with at least two housing bores formed therein. At least two treatment element shafts are arranged in the at least two housing bores. The at least two treatment element shafts can be driven in rotation about associated axes of rotation. The treatment element shafts are designed in embodiments to be driven in rotation in the same direction, i.e. in the same directions of rotation, and/or to mesh tightly. The rotational drive of the at least two treatment element shafts is performed by a drive motor via a branching gear. The multi-shaft screw machine is designed in embodiments as a co-rotating twin-shaft screw machine.

The dried plastic waste material and/or new plastic material is plasticized into a material melt by the multi-shaft screw machine. Subsequently, the material melt is processed or reprocessed by the multi-shaft screw machine. The plasticizing and/or the processing or reprocessing may in embodiments comprise at least one of the steps of degassing, mixing in, melting and homogenizing. In embodiments, at least one additive and/or new plastic material (virgin material), in embodiments new PET material, can be supplied to the multi-shaft screw machine. The raw material resulting from the processing or reprocessing can be reused for the production of plastic products or PET products. The raw material is, for example, filtered and/or granulated into granulate and/or further processed directly.

A method in which the plastic waste material is conveyed by a conveying gas and dried while being conveyed to the multi-shaft screw machine ensures simple, energy-efficient, economical, reliable and effective reprocessing. The flash dryer generates a flowing conveying gas. The flowing conveying gas is particularly heated for drying the plastic waste material. The flowing conveying gas conveys the plastic waste material in the conveying direction to the multi-shaft screw machine. While being conveyed, the plastic waste material is dried by the heated conveying gas. The conveying gas is in embodiments air or conveying air. The flowing conveying gas is generated, for example, by pressure conveying and/or suction conveying. The plastic waste material is in embodiments pneumatically conveyed. The plastic waste material is conveyed in co-current with the conveying gas, i.e. in the conveying direction. The conveying gas flows in the conveying line. For loading the conveying gas with the plastic waste material, the conveying line has in embodiments at least one feed opening.

The plastic waste material is dried gently. The plastic waste material is heated by a temperature ΔT by the flash dryer. For the temperature ΔT, the following applies in embodiments: 2° C.≤ΔT≤80° C., in embodiments 5° C.≤ΔT≤70° C., and in embodiments 10° C.≤ΔT≤60° C.

The plastic waste material is fed to the multi-shaft screw machine after the flash dryer, in embodiments without further heating and/or further drying. The dried plastic material is fed to the multi-shaft screw machine, in embodiments, at a temperature T_{K}, wherein the following applies in embodiments to the temperature T_{K}: 0° C.≤T_{K}≤100° C., in embodiments 10° C.≤T_{K}≤90° C., in embodiments 20° C.≤T_{K}≤80° C., in embodiments 30° C.≤T_{K}≤70° C., and in embodiments 40° C.≤T_{K}≤60° C. The dried plastic waste material is fed to the multi-shaft screw machine, in embodiments in a non-crystallized state.

A method in which a conveying gas in the conveying line has a temperature T_{G}, wherein: 70° C.≤T_{G}≤250° C., in embodiments 80° C.≤T_{G}≤220° C., and in embodiments 90° C.≤T_{G}≤190° C., ensures simple, energy-efficient, economical, reliable and effective reprocessing. The conveying gas has the temperature T_{G} in embodiments when the plastic waste material enters the conveying line. In embodiments, the temperature T_{G} is lower than a melting temperature T_{S} of the plastic waste material. For the melting temperature T_{S} of PET, the following applies in embodiments: 250° C.≤T_{S}≤260° C. The higher the temperature T_{G}, the higher the drying effect of the flash dryer. A higher drying effect can reduce the dwell time of the plastic waste material in the conveying gas and/or the specific conveying gas quantity per kilogram of plastic waste material.

A method in which the plastic waste material has a melting temperature T_{S} and a conveying gas in the conveying line has a temperature T_{G}, wherein: T_{S}−100° C.≤T_{G}≤T_{S}, in embodiments T_{S}−80° C.≤T_{G}≤T_{S}−10° C., and in embodiments T_{S}−60° C.≤T_{G}≤T_{S}−20° C., ensures simple, energy-efficient, economical, reliable and effective reprocessing. The conveying gas has the temperature T_{G} in embodiments when the plastic waste material enters the conveying line. The temperature T_{G} is lower than the melting temperature T_{S} of the plastic waste material. The higher the temperature T_{G}, the higher the drying effect of the flash dryer. Due to a higher drying effect, the dwell time of the plastic waste material in the conveying gas can be reduced.

A method in which a mass m_{G} of a conveying gas is loaded with a mass m_{M} of the plastic waste material, wherein: 0.3≤m_{M}/m_{G}≤4, in embodiments 0.4≤m_{M}/m_{G}≤3, and in embodiments 0.5≤m_{M}/m_{G}≤2, ensures simple, energy-efficient, economical, reliable and effective reprocessing. The ratio of the mass m_{M} of the plastic waste material to the mass m_{G} of the conveying gas is also referred to as the load. For example, if 1 kg of conveying gas is loaded with 1 kg of plastic waste material, the load ratio is: m_{M}/m_{G}=1. Too high a load ratio will impair the drying effect of the flash dryer. The specified ranges for the load apply in embodiments when the plastic waste material enters the conveying gas.

A method in which a conveying gas in the conveying line has a conveying speed v_{G}, wherein: 5 m/s≤v_{G}≤50 m/s, in embodiments 10 m/s≤v_{G}≤45 m/s, and in embodiments 15 m/s≤v_{G}≤40 m/s ensures simple, energy-efficient, economical, reliable and effective reprocessing. A high conveying speed v_{G} enhances the drying effect of the flash dryer and enables a short dwell time t_{G} of the waste plastic material in the conveying gas. As a result, drying is particularly energy-efficient and economical.

A method in which the plastic waste material has a dwell time t_{G} in a conveying gas, wherein: 2 s≤t_{G}≤10 s, in embodiments 3 s≤t_{G}≤8 s, and in embodiments 3 s≤t_{G}≤6 s, ensures simple, energy-efficient, economical, reliable and effective reprocessing. Due to the short dwell time t_{G}, drying of the plastic waste material by the flash dryer is particularly energy-efficient and economical. In embodiments, the dwell time t_{G} is defined as the time period between the entry of the plastic waste material into the conveying gas until the separation of the dried plastic waste material from the conveying gas.

A method in which the plastic waste material is deflected and/or rotated and/or dispersed and/or decelerated and/or accelerated while being conveyed ensures simple, energy-efficient, economical, reliable and effective reprocessing. At least one force is exerted on the plastic waste material while being conveyed in the conveying line, so that the plastic waste material is deflected and/or rotated and/or dispersed and/or decelerated and/or accelerated while being conveyed. In embodiments, at least one drying element serves to exert the force. The respective drying element enhances the process of drying the plastic waste material while it is being conveyed. The respective drying element is in embodiments part of the conveying line and/or integrated into the conveying line. In embodiments, the at least one drying element is formed as a deflection line portion, a vertical line portion, a cross-section change line portion, and/or a direction changing component. The direction changing component is, for example, a dispersing component and/or a swirl component. Due to the changing movement, in embodiments the changing speed and/or direction, of the plastic waste material, the drying effect of the flash dryer is improved and the process of drying is accelerated.

A method in which the plastic waste material, when fed into a conveying gas, has a feed humidity proportion ψ₁, wherein: 4000 ppm≤ψ₁≤50000 ppm, in embodiments 5000 ppm≤ψ₁≤35000 ppm, and in embodiments 6000 ppm≤ψ₁≤20000 ppm, and/or in which the dried plastic waste material, when discharged from a conveying gas, has a discharge humidity proportion ψ₂, wherein: 3000 ppm≤ψ₂≤6000 ppm, in embodiments 3500 ppm≤ψ₂≤5500 ppm, and in embodiments 4000 ppm≤ψ₂≤5000 ppm, ensures simple, energy-efficient, economical, reliable and effective reprocessing. The plastic waste material is moist when fed into the conveying gas or conveying line. The plastic waste material has a feed humidity proportion ψ₁. The feed humidity proportion ψ₁ is defined as follows:

$${ψ}_{1} = \frac{{m}_{W 1}}{{m}_{M}} = \frac{{m}_{M} - {m}_{M t}}{{m}_{W 1} + {m}_{M t}} ,$$

wherein:

m_{W1} denotes the mass of moisture or water upon feeding,

m_{M} denotes the mass of moist plastic waste material upon feeding,

m_{Mt} denotes the mass of dry or anhydrous plastic waste material.

Accordingly, the dried plastic waste material has a discharge humidity proportion ψ₂ when being discharged from the conveying gas or conveying line. The discharge humidity proportion ψ₂ is defined as follows:

$${ψ}_{2} = = \frac{{m}_{W 2}}{{m}_{M D}} = \frac{{m}_{M D} - {m}_{M t}}{{m}_{W 2} + {m}_{M t}} ,$$

wherein:

m_{W2} denotes the mass of moisture or water upon discharge,

m_{MD} denotes the mass of dried plastic waste material M_{D} upon discharge.

The unit ppm is an abbreviation for “parts per million” and describes the mass m_{W1} or m_{W2} in mg in mg related to the mass m_{M} or m_{MD} in kg. The humidity proportion ψ₁ or ψ₂ is determined by a water-selective measuring method, for example by Karl Fischer titration.

The moisture or humidity is composed of an internal humidity bound in the plastic waste material and a surface humidity. Accordingly, the feed humidity proportion ψ₁ is composed of an internal humidity ψ_{I} and a surface humidity ψ_{O1}. The following applies:

ψ₁=ψ_{I}+ψ_{O1}.

The internal humidity proportion ψ_{I} is bound in the plastic waste material and remains essentially constant through the process of drying the plastic waste material by the flash dryer. In contrast, the surface humidity proportion ψ_{O1} is located on the surface of the plastic waste material and is removed by the process of drying by the flash dryer to at least 70% by weight, in embodiments to at least 80% by weight, and in embodiments to at least 90% by weight. The following thus applies to the discharge humidity proportion ψ₂:

ψ₂=ψ_{I}+ψ_{O2},

wherein ψ_{O2} denotes the surface humidity proportion upon discharge of the dried plastic waste material. The following applies in embodiments:

0 ppm≤ψ_{O2}≤3000 ppm, in embodiments 100 ppm, ≤ψ_{O2}≤2500 ppm, and in embodiments 300 ppm≤ψ_{O2}≤2000 ppm.

A method in which the processing of the dried plastic waste material is performed by the multi-shaft screw machine with a throughput D, wherein: 500 kg/h≤D≤25000 kg/h, in embodiments 1000 kg/h≤D≤20000 kg/h, and in embodiments 1500 kg/h≤D≤15000 kg/h, ensures simple, energy-efficient, economical, reliable and effective reprocessing. Due to the fact that the plastic waste material is dried prior to being supplied to the multi-shaft screw machine, the dried plastic waste material requires less dehumidification and degassing during reprocessing in the multi-shaft screw machine. In embodiments, the dried plastic waste material does not cause foaming of the material melt in the multi-shaft screw machine. The throughput D of the multi-shaft screw machine can thus be significantly increased, which makes reprocessing more economical.

A method in which the dried plastic waste material is melted and degassed in the multi-shaft screw machine, wherein the degassing takes place in embodiments at a pressure p_{abs}, wherein: 3 mbar≤p_{abs}≤50 mbar, in embodiments 5 mbar≤p_{abs}≤30 mbar, in embodiments 10 mbar≤p_{abs}≤25 mbar, and in embodiments 15 mbar≤p_{abs}≤20 mbar, ensures simple, energy-efficient, economical, reliable and effective reprocessing. Due to the melting of the dried plastic waste material, in embodiments the bound internal humidity proportion is released. The released inner humidity proportion and, where applicable, a small amount of remaining surface humidity proportion are degassed by at least one degassing installation and discharged from the multi-shaft screw machine. Due to the fact that the humidity proportion is comparatively low, only a small humidity proportion has to be discharged or degassed from the multi-shaft screw machine. As a result, the at least one degassing installation can be operated at a higher pressure p_{abs} in the degassing process. Due to the higher pressure p_{abs}, the at least one degassing installation can be dimensioned to be smaller and more economical. This makes reprocessing more economical.

It is further an object of embodiments of the disclosure to provide a reprocessing system which enables simple, energy-efficient, economical, reliable and effective reprocessing of plastic waste material, in embodiments PET waste material.

This object is achieved by a reprocessing system for reprocessing plastic waste material, in embodiments PET waste material, having
a multi-shaft screw machine for plasticizing and reprocessing the plastic waste material, and
a feeding apparatus for feeding the plastic waste material into the multi-shaft screw machine,

wherein the feeding apparatus comprises a flash dryer for drying the plastic waste material in a conveying line. The advantages of the reprocessing system according to embodiments of the disclosure correspond to the advantages of the method according to embodiments of the disclosure for reprocessing plastic waste material, which have already been described. The reprocessing system according to embodiments of the disclosure can be embodied further with at least one feature described in connection with the method according to embodiments of the disclosure. Accordingly, the method according to embodiments of the disclosure can be further embodied by at least one feature described in connection with the reprocessing system according to embodiments of the disclosure.

The multi-shaft screw machine comprises in embodiments a housing having at least two housing bores formed therein. At least two treatment element shafts are arranged in the at least two housing bores. The at least two treatment element shafts can be driven in rotation about associated axes of rotation. The treatment element shafts are designed in embodiments to be driven in rotation in the same direction, i.e. in the same directions of rotation, and/or to mesh tightly. The rotational drive of the at least two treatment element shafts is performed by a drive motor via a branching gear. The multi-shaft screw machine is designed in embodiments as a co-rotating twin-shaft screw machine.

The flash dryer serves to dry the moist plastic waste material in the conveying line while it is being conveyed to the multi-shaft screw machine. The flash dryer conveys the plastic waste material in a conveying direction in the conveying line. The flash dryer is arranged upstream of the multi-shaft screw machine in the conveying direction. In embodiments, no further heating and/or drying of the plastic waste material takes place between the flash dryer and the multi-shaft screw machine.

A reprocessing system in which the flash dryer comprises a conveying line, a flow generator for generating a flowing conveying gas and a heating installation for heating the conveying gas ensures simple, energy-efficient, economical, reliable and effective reprocessing. By the flow generator, a flowing conveying gas is generated in the conveying line. The conveying gas is heated by the heating installation in order to dry the plastic waste material. In embodiments, the heating installation heats the flowing conveying gas. The conveying line comprises at least one feed opening for feeding the conveying gas and/or the plastic waste material. In embodiments, the conveying line comprises at least one feed opening for feeding the conveying gas and at least one feed opening for feeding the plastic waste material. The conveying line in embodiments comprises at least one discharge opening for discharging the dried plastic material. Between the at least one feed opening for feeding the plastic waste material and the at least one discharge opening for discharging the plastic waste material, the conveying line has a length L_{F}, wherein in embodiments: 5 m≤L_{F}≤100 m, in embodiments 10 m≤L_{F}≤70 m, and in embodiments 20 m≤L_{F}≤50 m. The conveying line is enclosed by an insulation layer, at least in portions, in embodiments over at least 90% of the length L_{F}.

The flow generator can be designed as a pressure or suction generator. The flow generator can be arranged in the conveying line. The flow generator is arranged in embodiments downstream of at least one filter and/or dust separator. The flow generator comprises, for example, a conveying fan.

The heating installation can be operated electrically and/or with a heated heating fluid, for example with water, steam, thermal oil and/or hot gas. The heating installation comprises in embodiments a heating device for heating a heating fluid and/or a heat exchanger for transferring thermal energy from the heating fluid to the conveying gas.

A reprocessing system in which the flash dryer comprises a separating installation for separating the dried plastic waste material from the conveying gas ensures simple, energy-efficient, economical, reliable and effective reprocessing. The separating installation is arranged in embodiments between the conveying line and the multi-shaft screw machine. In embodiments, a discharge opening of the conveying line opens into the separating installation. The separating installation is designed as a cyclone, for example. The separating installation serves to separate the dried plastic waste material from the moist conveying gas. In embodiments, a mixer is arranged between the separating installation and the multi-shaft screw machine for standardizing the plastic waste material, in embodiments different batches of the plastic waste material. The mixer comprises, for example, a container and at least one mixing element arranged therein for mixing the dried plastic waste material located in the container. In embodiments, no further drying of the plastic waste material takes place by the mixer. A possible temperature increase in the mixer is in embodiments less than 10° C., in embodiments less than 5° C., and in embodiments less than 1° C. The separating installation is in embodiments connected to a separator for separating fines from the moist conveying gas.

A reprocessing system in which the flash dryer comprises at least one drying element for improving the process of drying the plastic waste material ensures simple, energy-efficient, economical, reliable and effective reprocessing. The at least one drying element serves to improve or accelerate the drying of the moist plastic waste material. The at least one drying element serves in embodiments to exert a force on the plastic waste material so that the plastic waste material is deflected and/or set in rotation and/or dispersed and/or decelerated and/or accelerated while being conveyed. The at least one drying element is in embodiments part of the conveying line and/or integrated into the conveying line. The at least one drying element is formed in embodiments as a deflection line portion, vertical line portion, cross-section change line portion and/or direction change component, for example as a dispersion component and/or as a swirl component. In embodiments, the flash dryer has a number N of drying elements, wherein: 1≤N≤20, in embodiments 2≤N≤16, and in embodiments 4≤N≤12. In embodiments, the conveying line has a number U of deflection line portions, wherein: 1≤U≤10, in embodiments 2≤U≤8, and in embodiments 3≤U≤6. The deflection line portions serve to decelerate and accelerate the conveying gas or the conveyed plastic waste material, thus improving the drying process. The deflection line portions can be designed as pipe bends, as miter-sawn pipe portions welded together, as a T-piece, as a deflection pot and/or as a gamma-shaped pipe portion. The respective deflection line portion defines a deflection angle α, wherein in embodiments: 10°≤α≤150°, in embodiments 15°≤α≤135°, and in embodiments 200≤α≤120°. In embodiments, the flash dryer comprises at least one deflection line portion in conjunction with a vertical line portion. As a rule, the greater the drying effect of the at least one drying element, the higher the conveying energy to be applied.

A reprocessing system in which the feeding apparatus comprises a metering installation for loading the plastic waste material into the flash dryer and/or in which the feeding apparatus comprises a metering installation for feeding the dried plastic waste material into the multi-shaft screw machine ensures simple, energy-efficient, economical, reliable and effective reprocessing. A first metering installation is used to load the moist plastic waste material into the flash dryer. The first metering installation allows an exact loading of the plastic waste material into the conveying gas. The first metering installation comprises in embodiments a gravimetric metering unit and/or a volumetric metering unit and/or a feed screw machine. The metering installation opens into the conveying line. The first metering installation is in embodiments connected to at least one feed opening of the conveying line. The first metering installation is arranged downstream, in embodiments in a conveying direction, of a heating installation for heating a conveying gas. As a result, heated conveying gas is loaded with the plastic waste material.

The second metering installation serves to feed the dried plastic waste material into the multi-shaft screw machine. In embodiments, the metering installation comprises a gravimetric metering unit and/or a volumetric metering unit and/or a feed screw machine. In embodiments, the second metering installation comprises a mixer arranged upstream of a metering unit. The mixer serves to standardize the dried plastic waste material, in embodiments different batches of the plastic waste material. The mixer in embodiments comprises a container and at least one mixing element arranged therein for mixing the plastic waste material located in the container. In embodiments, the mixer is not used for further drying of the plastic waste material. A possible temperature increase of the plastic waste material in the container is in embodiments less than 10° C., in embodiments less than 5° C., and in embodiments less than 1° C. The second metering installation, in embodiments the metering unit, in embodiments opens into a feed opening of the multi-shaft screw machine.

A reprocessing system in which the multi-shaft screw machine comprises at least one degassing installation for degassing the dried plastic waste material ensures simple, energy-efficient, economical, reliable and effective reprocessing. By the at least one degassing installation, an internal moisture or internal humidity released during the melting process and a possibly still existing surface moisture or surface humidity of the plastic waste material are removed from the multi-shaft screw machine. Due to the fact that the plastic waste material has been dried by the flash dryer, in embodiments the surface moisture has been removed, the at least one degassing installation can be dimensioned to be smaller. This increases the economic efficiency of the reprocessing. The volume output of the at least one degassing installation depends on the humidity proportion of the dried plastic waste material, the throughput of the multi-shaft screw machine and the pressure p_{abs} required for degassing. In embodiments, the multi-shaft screw machine comprises at least one degassing opening, in embodiments at least two degassing openings, which are arranged one after the other in the conveying direction. In a degassing zone associated with the at least one degassing installation, the material melt has in embodiments a temperature T_{M}, wherein: 265° C.≤T_{M}≤300° C., in embodiments 270° C.≤T_{M}≤285° C.

The dwell time v_{S} of the material melt in the degassing zone is in embodiments 10 s≤v_{S}≤45 s, in embodiments 15 s≤v_{S}≤30 s. In embodiments, the at least one degassing installation has at least two degassing openings arranged one after the other in the conveying direction. In embodiments, the degassing zone is located between two degassing openings of the multi-shaft screw machine. The at least one degassing installation comprises in embodiments a vacuum pump. The at least one degassing installation, in embodiments the vacuum pump, is in embodiments operated with a volume flow rate per kg of material melt which is between 0.3 m³/kg and 2.5 m³/kg, in embodiments between 0.5 m³/kg and 1.5 m³/kg, and in embodiments between 0.6 m³/kg and 1.2 m³/kg.

A reprocessing system comprising a control installation for controlling the feeding apparatus and/or the multi-shaft screw machine ensures simple, energy-efficient, economical, reliable and effective reprocessing. In embodiments, the control installation is configured such that the reprocessing system is operable according to at least one feature described in connection with claims 1 to 17.

Further features, advantages and details of embodiments of the disclosure will be apparent from the following description.

### BRIEF DESCRIPTION OF THE DRAWING

FIG. 1 shows a schematic view of a reprocessing system for reprocessing plastic waste material, in embodiments PET waste material, having a feeding apparatus and a multi-shaft screw machine,

FIG. 2 shows an enlarged and sectional view of a flash dryer of the feeding apparatus in FIG. 1,

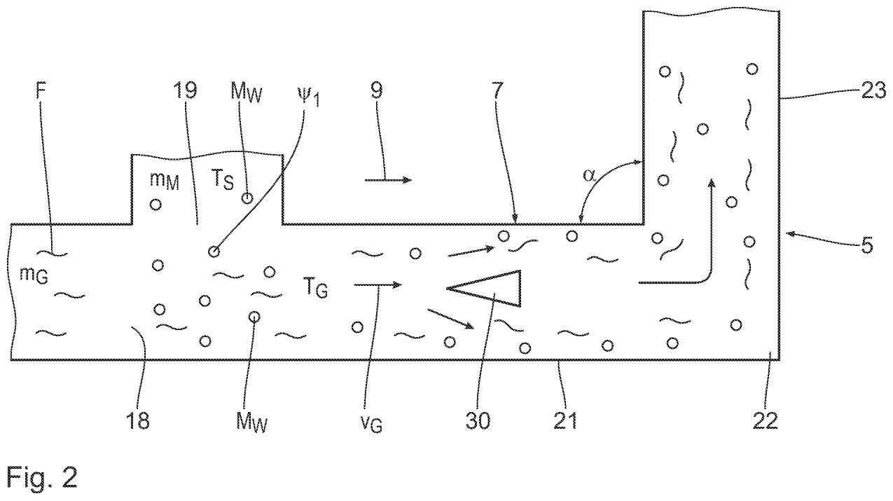

FIG. 3 shows a partially cut side view of the multi-shaft screw machine in FIG. 1, and

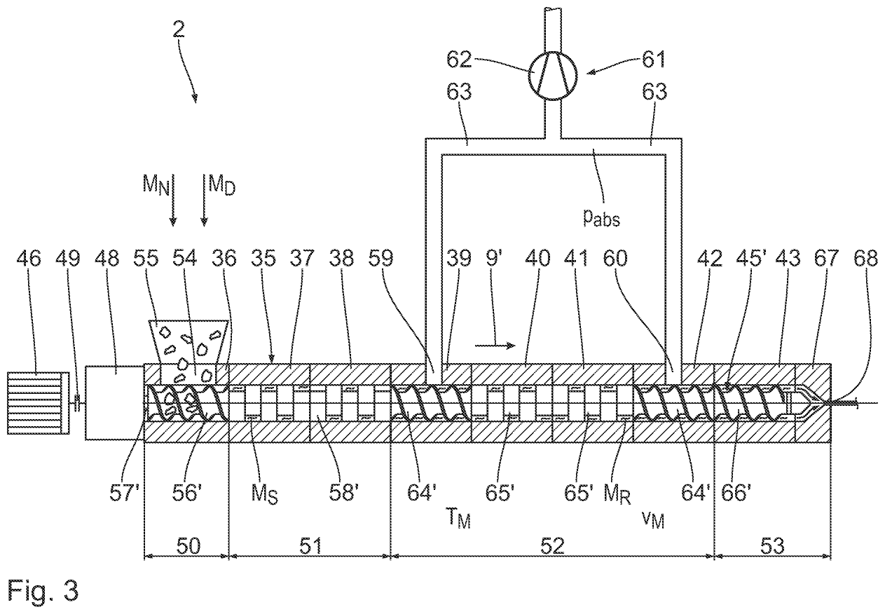

FIG. 4 shows a partial cutaway top view of the multi-shaft screw machine in FIG. 3.

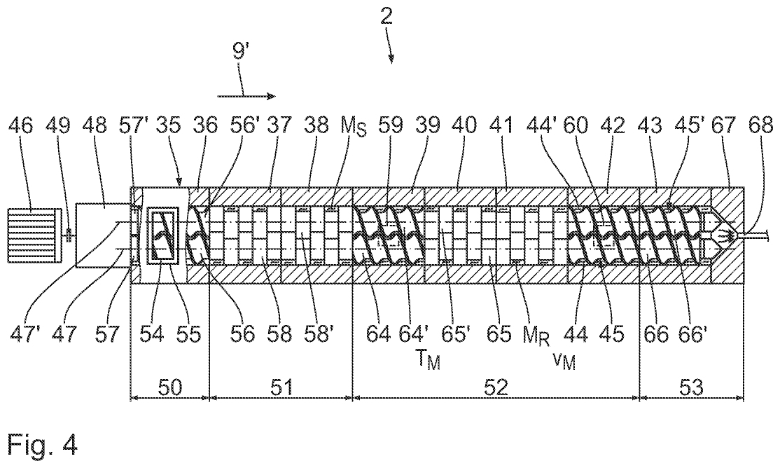

### DETAILED DESCRIPTION

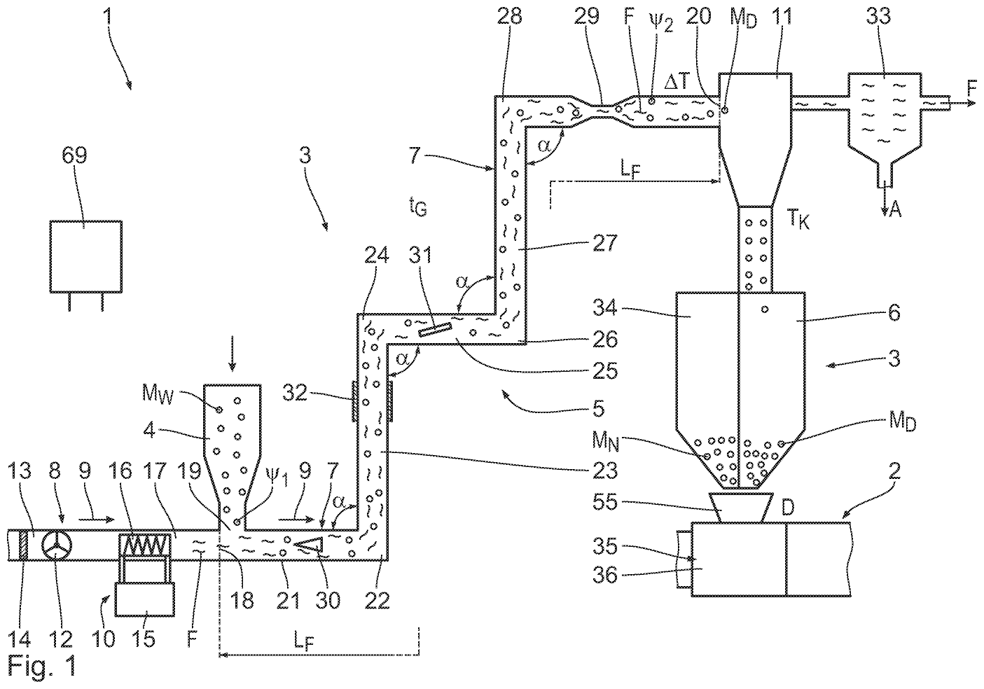

A reprocessing system 1 shown in FIG. 1 serves for the reprocessing of moist plastic waste material M_{W}. The plastic waste material M_{W} is formed as PET waste material (PET: polyethylene terephthalate). The reprocessing system 1 comprises a multi-shaft screw machine 2 for plasticizing and reprocessing the plastic waste material, and a feeding apparatus 3 for feeding the plastic waste material into the multi-shaft screw machine 2.

The feeding apparatus 3 comprises a first metering installation 4, a flash dryer 5 and a second metering installation 6. The first metering installation 4 is used to load the moist plastic waste material M_{W} into the flash dryer 5. The first metering installation 4 has, for example, a feed screw machine and/or a gravimetric metering unit and/or a volumetric metering unit.

The flash dryer 5 serves to dry the moist plastic waste material M_{W}. The flash dryer 5 comprises a conveying line 7, a flow generator 8 for generating a conveying gas F flowing in a conveying direction 9, a heating installation 10 for heating the conveying gas F, and a separating installation 11 for separating the waste plastic material M_{D} dried by the flash dryer 5 from the conveying gas F which is moist due to the process of drying.

The flow generator 8 has a conveying fan 12 which sucks in the conveying gas F via a suction line 13 and a filter 14 arranged therein. The conveying gas F is in embodiments air.

The heating installation 10 is connected to the flow generator 8 via a connection line 17 and is arranged downstream from the flow generator 8 in the conveying direction 9. The heating installation 10 comprises a heating device 15 for heating a heating fluid and a heat exchanger 16 connected to the heating device 15 for transferring thermal energy from the heating fluid to the flowing conveying gas F. The heating fluid is, for example, water, steam, thermal oil or a gas. The heat exchanger 16 is arranged within the connection line 17. Alternatively, the heating installation 10 can be designed for direct electrical heating of the conveying gas F.

The connection line 17 is connected to the conveying line 7 via a conveying gas feed opening 18. The conveying line 7 starts at a feed opening 19 for feeding the plastic waste material M_{W}. The conveying line 7 leads to the separating installation 11 and opens into the separating installation 11. For this purpose, the conveying line 7 has a discharge opening 20. The conveying line 7 ends at the discharge opening 20. The conveying line 7 has a length L_{F} from the feed opening 18 to the discharge opening 20, wherein in embodiments: 5 m≤L_{F}≤100 m, in embodiments 10 m≤L_{F}≤70 m, and in embodiments 20 m≤L_{F}≤50 m. The conveying line 7 can be coated with an insulation layer 32 to reduce energy losses. The insulation layer 32 is only indicated in FIG. 1.

In the conveying direction 9, the conveying line 7 successively has a first horizontal line portion 21, a first deflection line portion 22, a first vertical line portion 23, a second deflection line portion 24, a second horizontal line portion 25, a third deflection line portion 26, a second vertical line portion 27, a fourth deflection line portion 28, and a cross-section change line portion 29. In the first horizontal line portion 21, a first direction changing component 30 is arranged, which is designed as a dispersing component. In the second horizontal line portion 25, a second direction-changing component 31 is arranged, which is designed as a swirl component. The deflection line portions 22, 24, 26, 28, the vertical line portions 23, 27, the cross-section change line portion 29, and the direction change components 30, 31 integrated in the horizontal line portions 21, 25 each form a drying element which serves to improve drying of the plastic waste material M_{W}. Drying is accelerated by the respective drying element. The drying elements are part of the flash dryer 5.

The flash dryer 5 has a number N of drying elements in embodiments, wherein 1≤N≤20, in embodiments 2≤N≤16, and in embodiments 4≤N≤12. The conveying line 7 has a number U of deflection line portions in embodiments, wherein 1≤U≤10, in embodiments 2≤U≤8, and in embodiments 3≤U≤6.

The deflection line portions 22, 24, 26, 28 each enclose a deflection angle α, wherein in embodiments 10°≤α≤150°, in embodiments 15°≤α≤135°, and in embodiments 20°≤α≤120°.

The separating installation 11 serves to separate the dried plastic waste material M_{D} from the conveying gas F which is moist due to the process of drying. The separating installation 11 is connected to the second metering installation 6 for feeding the dried plastic waste material M_{D}. The separating installation 11 is further connected to a separator 33. The separator 33 serves to separate the fines A or dust contained in the conveying gas F. The separator 33 is part of the flash dryer 5.

The second metering installation 6 serves to feed the dried plastic waste material M_{D} into the multi-shaft screw machine 2. The second metering installation 6 comprises, for example, a feed screw machine and/or a gravimetric metering unit and/or a volumetric metering unit. For feeding new plastic material M_{N}, the feeding apparatus 3 has a third metering installation 34. The third metering installation 34 comprises, for example, a feed screw machine and/or a gravimetric metering unit and/or a volumetric metering unit.

The multi-shaft screw machine 2 serves to plasticize the dried plastic waste material M_{D} and/or the new plastic material M_{N} into a material melt M_{S} and to process or reprocess the material melt M_{S} into raw material M_{R}. The multi-shaft screw machine 2 is configured as a co-rotating twin-shaft screw machine. The multi-shaft screw machine 2 comprises a housing 35 made of a plurality of housing portions 36 to 43 arranged one after the other. The housing portions 36 to 43 are joined together to form the housing 35. Two housing bores 44, 44′ are formed in the housing 35 parallel to each other and interpenetrating each other, which have the shape of a horizontal figure eight in cross-section. Two treatment element shafts 45, 45′ are arranged concentrically in the housing bores 44, 44′ and can be driven in rotation about associated axes of rotation 47, 47′ by a drive motor 46. A branching gear 48 and a coupling 49 are arranged between the treatment element shafts 45, 45′ and the drive motor 46. The treatment element shafts 45, 45′ are driven in the same direction, i.e. in the same directions of rotation about the axes of rotation 47, 47′, by the drive motor 46.

The multi-shaft screw machine 2 has, in succession in a conveying direction 9′, an intake zone 50, a plasticizing and homogenizing zone 51, a degassing zone 52 and a discharge zone 53.

In the intake zone 50, the housing portion 36 has a feed opening 54. An inlet hopper 55 opens into the feed opening 54. In the intake zone 50, the treatment element shafts 45, 45′ comprise screw elements 56, 56′, which are arranged in a rotationally fixed manner on associated shafts 57, 57′ and serve for conveying.

In the plasticizing and homogenizing zone 51, the dried plastic waste material M_{D} and/or the new plastic material M_{N} is plasticized or melted and the material melt M_{S} is homogenized. For plasticizing and homogenizing, kneading elements 58, 58′ are arranged in a rotationally fixed manner on the shafts 57, 57′ in the plasticizing and homogenizing zone 51. In embodiments, kneading blocks are arranged on the shafts 57, 57′ in the plasticizing and homogenizing zone 51, which comprise a plurality of kneading disks formed in one piece with one another.

The degassing zone 52 serves for degassing the material melt M_{S}. Degassing openings 59, 60 are formed in the housing portions 39, 42 for degassing. The multi-shaft screw machine 2 comprises a degassing installation 61 connected to the degassing openings 59, 60. The degassing installation 61 comprises a vacuum pump 62, which are connected to the degassing openings 59, 60 via degassing lines 63. In the degassing zone 52, screw elements 64, 64′ and kneading elements 65, 65′ are arranged on the shafts 57, 57′ in a rotationally fixed manner. In embodiments, kneading blocks are arranged in the degassing zone 52, which are formed from a plurality of kneading disks connected to one another in one piece.

In the discharge zone 53, screw elements 66, 66′ are arranged in a rotationally fixed manner on the shafts 57, 57′ in order to discharge the raw material MR. A nozzle plate 67 closing off the housing 35 is arranged on the last housing portion 43 and forms a discharge opening 68.

The reprocessing system 1 includes a control installation 69 for controlling the feeding apparatus 3 and/or the multi-shaft screw machine 2. The control installation 69 is in signal communication with the feeding apparatus 3 and the multi-shaft screw machine 2.

The functional principle of the reprocessing system 1 and a method for reprocessing the plastic waste material M_{W} are described below:

The first metering installation 4 is supplied with the moist plastic waste material M_{W}. The moist plastic waste material M_{W} is comminuted and washed. The moist plastic waste material M_{W} is transported, for example, in big bags. The plastic waste material M_{W} has a melting temperature T_{S}, wherein in embodiments: 250° C.≤T_{S}≤260° C.

The conveying gas F is moved by the flow generator 8 in the conveying direction 9 at a conveying speed v_{G}. The following applies in embodiments to the conveying speed v_{G} in the conveying line: 5 m/s≤v_{G}≤50 m/s, in embodiments 10 m/s≤v_{G}≤45 m/s, and in embodiments 15 m/s≤v_{G}≤40 m/s.

By the heating installation 10, the conveying gas F is heated and has a temperature T_{G} in the conveying line 7. The following applies in embodiments to the temperature T_{G}: 70° C.≤T_{G}≤250° C., in embodiments 80° C.≤T_{G}≤220° C., and in embodiments 90° C.≤T_{G}≤190° C.

For the temperature T_{G}, depending on the melting temperature T_{S}, the following applies in embodiments: T_{S}−100° C.≤T_{G}<T_{S}, in embodiments T_{S}−80° C.≤T_{G}≤T_{S}−10° C., and in embodiments T_{S}−60° C.≤T_{G}≤T_{S}−20° C.

The control installation 69 controls the first metering installation 4 and the flow generator 8 in such a way that a mass m_{G} of the conveying gas F is loaded with a mass m_{M} of the plastic waste material M_{W}. The ratio m_{M}/m_{G} is also referred to as the load. For the load, the following applies in embodiments: 0.3≤m_{M}/m_{G}≤4, in embodiments 0.4≤m_{M}/m_{G}≤3, and in embodiments 0.5≤m_{M}/m_{G}≤2.

The plastic waste material M_{W} has a feed humidity proportion ψ₁ when being fed into the conveying gas F, wherein: 4000 ppm≤ψ₁≤50000 ppm, in embodiments 5000 ppm≤ψ₁≤35000 ppm, and in embodiments 6000 ppm≤ψ₁≤20000 ppm. The plastic waste material M_{W} is dried by the flash dryer 5 in the conveying line 7, so that the dried plastic waste material M_{D} has a discharge humidity proportion ψ₂ when being discharged from the conveying gas F, wherein: 3000 ppm≤ψ₂≤6000 ppm, in embodiments 3500 ppm≤ψ₂≤5500 ppm, and in embodiments 4000 ppm≤ψ₂≤5000 ppm.

The feed humidity proportion ψ₁ is defined as follows:

$${ψ}_{1} = \frac{{m}_{W 1}}{{m}_{M}} = \frac{{m}_{M} - {m}_{M t}}{{m}_{W 1} + {m}_{M t}} ,$$

wherein:

m_{W1} denotes the mass of moisture or water upon feeding,

m_{M} denotes the mass of moist plastic waste material M_{W} upon feeding,

m_{Mt} denotes the mass of dry or anhydrous plastic waste material.

The discharge humidity proportion ψ₂ is defined as follows:

$${ψ}_{2} = = \frac{{m}_{W 2}}{{m}_{M D}} = \frac{{m}_{M D} - {m}_{M t}}{{m}_{W 2} + {m}_{M t}} ,$$

wherein:

m_{W2} denotes the mass of moisture or water upon discharge,

m_{MD} denotes the mass of dried plastic waste material M_{D} upon discharge.

The unit ppm is an abbreviation for “parts per million” and describes the mass m_{W1} or m_{W2} in mg in mg related to the mass m_{M} or m_{MD} in kg.

The moisture or humidity is composed of an internal humidity bound in the plastic waste material M_{W} or M_{D} and a surface humidity. Accordingly, the feed humidity proportion ψ₁ is composed of an internal humidity ψ_{I} and a surface humidity ψ_{O1}. The following applies:

ψ₁=ψ_{I}+ψ_{O1}.

The internal humidity proportion ψ_{I} is bound in the plastic waste material M_{W} or M_{D} and remains essentially constant despite the process of drying the plastic waste material M_{W} by the flash dryer 5. In contrast, the surface humidity proportion ψ_{O1} is located on the surface of the plastic waste material M_{W} and is removed by the process of drying by the flash dryer 5 to at least 70% by weight, in embodiments to at least 80% by weight, and in embodiments to at least 90% by weight. The following thus applies to the discharge humidity proportion ψ₂:

ψ₂=ψ_{I}+ψ_{O2},

wherein ψV_{O2} denotes the surface humidity proportion upon discharge of the dried plastic waste material M_{D}. The following applies in embodiments:

0 ppm≤ψ_{O2}≤3000 ppm, in embodiments 100 ppm≤ψ_{O2}≤2500 ppm, and in embodiments 300 ppm≤ψ_{O2}≤2000 ppm.

The plastic waste material M_{W} is conveyed by the conveying gas F in co-current in the conveying line 7 and dried while being conveyed to the multi-shaft screw machine 2. The drying elements improve the drying or the drying effect and accelerate the drying process of the plastic waste material M_{W}. At least one force is exerted on the plastic waste material M_{W} by the drying elements, thereby improving the drying effect. The plastic waste material M_{W} is dispersed in the first horizontal line portion 21 by the first direction change component 30 or the dispersing component, and then deflected by the deflection angle α by the first deflection line portion 22. The forces thereby exerted on the plastic waste material M_{W} enhance the drying effect and accelerate the process of drying. In the first vertical line portion 23, the conveying speed v_{G} is reduced due to gravity. As a result of the deceleration, on the one hand a force is exerted on the plastic waste material M_{W} and on the other hand a dwell time t_{G} of the plastic waste material M_{W} in the conveying gas F is increased. By the second deflection line portion 24, the plastic waste material M_{W} is again deflected by a deflection angle α, then rotated in the second horizontal line portion 25 by the second direction change component 31 or the swirl component, and again deflected by a deflection angle α by the third deflection line portion 26. The forces exerted through this enhance the drying effect and accelerate the drying process. Due to the second horizontal line portion 25, the plastic waste material M_{W} is accelerated again in the meantime and then decelerated again in the second vertical line portion 27. By the second vertical line portion 27, the dwell time t_{G} can be further increased. Subsequently, by the fourth deflection line portion 28, the plastic waste material M_{W} is again deflected by a deflection angle α and first accelerated and then decelerated again in the horizontally arranged cross-section change line portion 29. The forces exerted through this enhance the drying effect and accelerate the drying process. The plastic waste material M_{W} has a dwell time t_{G} in the conveying line 7 or in the conveying gas F, wherein, in embodiments: 2 s≤t_{G}≤10 s, in embodiments 3 s≤t_{G}≤8 s, and in embodiments 3 S≤t_{G}≤6 s. When the plastic waste material M_{W} exits the conveying line 7 through the discharge opening 20, it is referred to as dried plastic waste material M_{D}.

By the separating installation 11, the dried plastic waste material M_{D} is separated from the moist conveying gas F. The dried plastic waste material M_{D} is fed to the second metering installation 6. The moist conveying gas F is fed to the separator 33, in which the fines A are separated. The filtered conveying gas F flows back into the environment or to the flow generator 8, so that the heat or thermal energy of the conveying gas F can be used again via heat exchangers.

The plastic waste material M_{W} is heated by a temperature ΔT by the flash dryer 5. In embodiments, the following applies to the temperature ΔT: 2° C.≤ΔT≤80° C., in embodiments 5° C.≤ΔT≤70° C., and in embodiments 10° C.≤ΔT≤60° C.

The plastic waste material M_{D} is fed to the multi-shaft screw machine 2 after the flash dryer 5, in embodiments without further heating and/or further drying. The dried plastic waste material M_{D} is fed to the multi-shaft screw machine 2 in embodiments at a temperature T_{K}, wherein for the temperature T_{K} in embodiments applies: 0° C.≤T_{K}≤100° C., in embodiments 10° C.≤T_{K}≤90° C., in embodiments 20° C.≤T_{K}≤80° C., in embodiments 30° C.≤T_{K}≤70° C., and in embodiments 40° C.≤T_{K}≤60° C. The dried plastic waste material M_{D} is fed to the multi-shaft screw machine 2, in embodiments in a non-crystallized state.

The dried plastic waste material M_{D} is fed by the second metering installation 6 via the inlet hopper 55 and the feed opening 54 into the multi-shaft screw machine 2. If desired or necessary, new plastic material M_{N} can be fed into the multi-shaft screw machine 2 by the third metering installation 34 via the inlet hopper 55 and the feed opening 54.

The fed plastic waste material M_{D} and/or the new plastic material M_{N} is conveyed in the intake zone 50 in the conveying direction 9′ to the plasticizing and homogenizing zone 51. In the plasticizing and homogenizing zone 51, the plastic waste material M_{D} and/or the new plastic material M_{N} is plasticized and homogenized. Plasticizing releases the internal humidity bound in the plastic waste material M_{D}. The released internal humidity and any remaining surface humidity are removed from the housing bores 44, 44′ in the degassing zone 52. For this purpose, a pressure p_{abs} is generated by the vacuum pump and the humidity prevailing in the housing bores 44, 44′ is extracted via the degassing openings 59, 60 and the degassing lines 63. For the pressure p_{abs} upon degassing, the following applies in embodiments: 3 mbar≤p_{abs}≤50 mbar, in embodiments 5 mbar≤p_{abs}≤30 mbar, in embodiments 10 mbar≤p_{abs}≤25 mbar, and in embodiments 15 mbar≤p_{abs}≤20 mbar.

Due to the fact that the surface humidity has been essentially completely removed from the moist plastic waste material M_{W} by the flash dryer 5, only the internal humidity, i.e. considerably less humidity, has to be removed from the material melt M_{S}, which has been generated from the dried plastic waste material M_{D}. This means that the degassing installation 61 can be of smaller dimensions and operated at a lower pressure p_{abs}.

The material melt M_{S} has a temperature T_{M} in the degassing zone 52, wherein in embodiments: 265° C.≤T_{M}≤300° C., in embodiments 270° C.≤T_{M}≤285° C. The dwell time v_{M} of the material melt M_{S} in the degassing zone 52 is in embodiments between 10 s and 45 s, and in embodiments between 15 s and 30 s. Related to 1 kg of material melt M_{S}, the degassing installation 61 is operated with a volume flow rate of 0.3 m³/kg to 2.5 m³/kg, in embodiments 0.5 m³/kg to 1.5 m³/kg, and in embodiments 0.6 m³/kg to 1.2 m³/kg.

Through plasticizing, homogenizing and degassing, the plastic waste material M_{D} is processed or reprocessed into new raw material M_{R}. The resulting raw material M_{R} is then discharged via the discharge zone 53 through the discharge opening 68. The raw material M_{R} can then be further treated in the usual way, for example filtered and/or granulated.

Due to the fact that dried plastic waste material M_{D} is fed to the multi-shaft screw machine 2, the processing by the multi-shaft screw machine 2 can be performed with a higher throughput D. For the throughput D, the following applies in embodiments: 500 kg/h≤D≤25000 kg/h, in embodiments 1000 kg/h≤D≤20000 kg/h, and in embodiments 1500 kg/h≤D≤15000 kg/h.

The flash dryer 5 enables simple, energy-efficient and economical drying of the moist plastic waste material M_{W}. The flash dryer 5 requires little space, has low energy consumption and low investment and operating costs. The plastic waste material M_{W} is gently dried. Drying simplifies subsequent reprocessing by the multi-shaft screw machine 2. Due to the fact that less humidity has to be removed from the multi-shaft screw machine 2, the degassing installation 61 can be of smaller dimensions and operated at a lower pressure p_{abs}. As a result, the throughput D can be increased. Overall, the method or the reprocessing system 1 enables simple, energy-efficient, economical, reliable and effective reprocessing of the plastic waste material M_{W}, in embodiments of PET waste material.

What is claimed is:

1. A method for recycling plastic waste material comprising the following steps:
providing plastic waste material (M_{W}),
drying the plastic waste material (M_{W}) by a flash dryer (5) in a conveying line (7),
feeding the dried plastic waste material (M_{D}) into a multi-shaft screw machine (2), and
reprocessing the dried plastic waste material (M_{D}) by the multi-shaft screw machine (2).

2. The method according to claim 1, wherein the plastic waste material is PET waste material.

3. The method according to claim 1, wherein the plastic waste material (M_{W}) is conveyed by a conveying gas (F) and dried while being conveyed to the multi-shaft screw machine (2).

4. The method according to claim 1, wherein a conveying gas (F) in the conveying line (7) has a temperature T_{G}, wherein: 70° C.≤T_{G}≤250° C.

5. The method according to claim 1, wherein the plastic waste material (M_{W}) has a melting temperature T_{S} and a conveying gas (F) in the conveying line (7) has a temperature T_{G}, wherein: T_{S}−100° C.≤T_{G}<T_{S}.

6. The method according to claim 1, wherein a mass m_{G} of a conveying gas (F) is loaded with a mass m_{M} of the plastic waste material (M_{W}), wherein: 0.3≤m_{M}/m_{G}≤4.

7. The method according to claim 1, wherein a conveying gas (F) in the conveying line (7) has a conveying speed v_{G}, wherein: 5 m/s≤v_{G}≤50 m/s.

8. The method according to claim 1, wherein the plastic waste material (M_{W}) has a dwell time t_{G} in a conveying gas (F), wherein: 2 s≤t_{G}≤10 s.

9. The method according to claim 1, wherein the plastic waste material (M_{W}) is at least one of deflected and rotated and dispersed and decelerated and accelerated while being conveyed.

10. The method according to claim 1, wherein at least one of the plastic waste material (M_{W}), when fed into a conveying gas (F), has a feed humidity proportion ψ₁, wherein: 4000 ppm≤ψ₁≤50000 ppm, and the dried plastic waste material (M_{D}), when discharged from a conveying gas (F), has a discharge humidity proportion ψ₂, wherein: 3000 ppm≤ψ₂≤6000 ppm.

11. The method according to claim 1, wherein the processing of the dried plastic waste material (M_{D}) is performed by the multi-shaft screw machine (2) with a throughput D, wherein: 500 kg/h≤D≤25000 kg/h.

12. The method according to claim 1, wherein the dried plastic waste material (M_{D}) is melted and degassed in the multi-shaft screw machine (2).

13. The method according to claim 12, wherein the degassing takes place at a pressure p_{abs}, wherein: 3 mbar≤p_{abs}≤50 mbar.

14. A reprocessing system for reprocessing plastic waste material having
a multi-shaft screw machine (2) for plasticizing and reprocessing the plastic waste material (M_{W}), and
a feeding apparatus (3) for feeding the plastic waste material (M_{D}) into the multi-shaft screw machine (2),
wherein the feeding apparatus (3) comprises a flash dryer (5) for drying the plastic waste material (M_{W}) in a conveying line (7).

15. The reprocessing system according to claim 14, wherein the plastic waste material is PET waste material.

16. The reprocessing system according to claim 14, wherein the flash dryer (5) comprises a conveying line (7), a flow generator (8) for generating a flowing conveying gas (F) and a heating installation (10) for heating the conveying gas (F).

17. The reprocessing system according to claim 14, wherein the flash dryer (5) comprises a separating installation (11) for separating the dried plastic waste material (M_{D}) from the conveying gas (F).

18. The reprocessing system according to claim 14, wherein the flash dryer (5) comprises at least one drying element (22, 23, 24, 26, 27, 28, 29, 30, 31) for improving the process of drying the plastic waste material (M_{W}).

19. The reprocessing system according to claim 14, wherein at least one of the feeding apparatus (3) comprises a metering installation (4) for loading the plastic waste material (M_{W}) into the flash dryer (5), and
the feeding apparatus (3) comprises a metering installation (6) for feeding the dried plastic waste material (M_{D}) into the multi-shaft screw machine (2).

20. The reprocessing system according to claim 14, wherein the multi-shaft screw machine (2) comprises at least one degassing installation (61) for degassing the dried plastic waste material (M_{D}).

21. The reprocessing system according to claim 14, comprising a control installation (69) for controlling at least one of the feeding apparatus (3) and the multi-shaft screw machine (2).
